(19) United States
(12) Patent Application Publication
(10) Pub. No.: US 2009/0181230 A1
(43) Pub. Date: Jul. 16, 2009

(54) Method and device for producing flat glass according to the float method

(75) Inventors: Carsten Schumacher, Horbach (DE); Armin Vogl, Jena (DE); Frank Klette, Jena (DE); Christian Kunert, Mainz-Kastel (DE); Bernhard Langner, Mainz (DE); Andreas Morstein, Jena (DE); Andreas Roters, Mainz (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott AG, Mainz (DE)

(21) Appl. No.: 11/663,249

(22) PCT Filed: Sep. 9, 2005
(86) PCT No.: PCT/EP2005/09697

§ 371 Date: Apr. 13, 2007

(30) Foreign Application Priority Data
Sep. 18, 2004 (DE) 10 2004 045 667.4

(51) Int. Cl. B32B 17/00; C03B 18/02; C03B 18/00; C03C 3/00

(52) U.S. Cl. 428/220; 65/99.4; 65/182.1; 501/11

(57) ABSTRACT

A method for reducing surface defects during production of float glass having a transformation temperature Tg of at least 600° C. is provided. A method for removing impurities from the surface of the glass band in the floating chamber by molten metal flowing over the glass band is also provided. The undesired spreading of the molten metal on the glass band is limited in a contactless manner. A device is also provided for carrying out the method, in addition to a floating glass having a transformation temperature of at least 600° C., which has a maximum of 3 surface defects (top specks) having a size greater than 35 μm per m² when it leaves the floating chamber.

### BACKGROUND

The subject matter of the invention is a method and a device for producing flat glass according to the float method, in which molten glass in the form of an endless ribbon moves forwards in a float chamber on a bath of molten metal, the glass ribbon is cooled and solidified, and the solidified glass ribbon is lifted from the bath.

Due to the high temperatures that prevail in the float chamber of a float glass installation, it cannot be avoided that components are vaporized both from the molten glass and also from the molten metal (typically tin or tin alloys), which then precipitate at cooler positions of the float chamber. Due to baffles in the top part of the float chamber and due to suitable guidance of the process gas, it is largely prevented that such condensed components could be led from there to the glass ribbon and there form a deposit designated as “Top Specks.” The glass produced in this way has sufficient freedom from particles on its surface for many application purposes.

There are also applications, however, for which a glass, as it comes out of a float chamber, does not have a sufficient surface purity. This applies especially to refractory glasses, e.g., aluminosilicate glasses and borosilicate glasses, especially for display applications. For these cases, up to now the glass had to be cleaned after its production, generally for the first time during the finishing work according to the blank for the final format, which is complicated and generates high costs. Thus, it is known from U.S. Pat. No. 3,284,181 to etch the bottom side of the glass ribbon, which has been in contact with the tin bath, with an HF solution, in order to remove the glass layer carrying impurities of diffused tin ions.

This idea was taken up in JP 92 95 833 in order to remove small foreign particles from the surface of the glass ribbon. Outside of the use of hydrofluoric acid, an aqueous, acidic solution containing bivalent chromium ions can also be used. After this acid treatment, however, polishing of the glass ribbon is still necessary. Also according to JP 92 95 832, the surface of the glass ribbon is etched with an acidic solution containing chromium²⁺ ions. Another etching method is described in JP 1008 5684 A. Here, an ammonium halide is pyrolized on the greatly heated glass ribbon and the impurities on the surface of the glass ribbon volatize in the form of easily vaporizing halides.

All of these solutions for removing tin impurities from the glass surface take place as finishing steps. They are complicated and expensive, especially due to the necessary preparation and disposal of the etching solutions and reaction products.

From U.S. Pat. No. 3,798,016 a method for modifying the surface of a glass ribbon located on a float bath is known, in which electrolytic lead ions are diffused into the surface of the glass ribbon connected as a cathode from a molten lead located on the glass ribbon at a high temperature and under application of an electric current. With this method, a heat reflective glass with gray-bronze color is generated. Due to the high temperature generated by the electric current and the low boiling point of lead, a portion of the lead vaporizes and condenses again behind the diffusion zone viewed in an advancing direction on the glass ribbon, which is colder at this location. This lead surface is separated again by molten lead, which is still in the float chamber and which is held stationary by means of a copper bar. Eliminating top specks is not discussed in this document.

In this method, the metal used for removing the lead impurities is held stationary by adhesion on a metal rail. Because the adhesive forces are limited, the metal rail must be positioned very precisely at a very short spacing above the glass ribbon. The rail, which must be very long for wide glass ribbons, is very difficult to position exactly and can become easily distorted in the hot float-bath atmosphere, whereby it can lead to contact of the rail with the surface of the glass ribbon. This leads immediately to rejects. All of these problems have led to the result that for the about 30 years since the publication of this document, top specks are still removed by means of the cited complicated etching method.

### SUMMARY

Therefore, there is the problem of finding a method and a device for producing glass according to the float method, in which cleaning the surface of the glass ribbon from top specks still takes place in the float chamber, i.e., a glass ribbon that is largely free from impurities on the glass surface leaves the float chamber, and in which there is no risk that the glass surface will be damaged through contact with baffles.

This problem is solved by the method according to claim 1 and also by the device according to claim 9. Another subject matter of the invention is a float glass with a high surface quality according to claim 15.

In the method, impurities located on the top side of the glass ribbon (so-called top specks) are removed by treating the top side of the glass ribbon with a cleaning fluid comprised of a fluid metal still within the float chamber. The spreading of the cleaning fluid on the glass ribbon is controlled in a contactless manner, especially through a gas flow blowing on the metal or through the use of electric or electromagnetic fields or currents.

The cleaning fluid can be not only molten lead, but also tin, copper, silver, gold, bismuth, gallium, indium, germanium, and alloys of these metals or the float-bath fluid itself. Because the float-bath fluid is already present in large quantities, its use is especially preferred. In addition, it is also in no way disruptive if it is led into the float bath and because then separate storage containers for the cleaning fluid are not necessary. It is also possible, however, to use fresh float-bath fluid that has not yet been used or cleaned.

Impurities, e.g., metals, for example, the metals named above, can be present in the float-bath fluid used for cleaning as long as they are not disruptive to the operation of the float bath. If the float-bath fluid used as a cleaning fluid is not led in large quantities into the float bath, impurities of up to 10 wt. % can be tolerated in the fluid.

If other metals listed above or their alloys are used as the cleaning fluid, care must be taken, just from economical reasons, that as much as possible no cleaning fluid is led into the float bath. Small quantities, however, here are also not usually disruptive.

The impurities are flushed away by the cleaning fluid or taken up by it.

To avoid undesired cooling of the glass by the cleaning fluid, it should have the approximate temperature of the float bath at this position. In general, those are temperatures between 400 and 1050° C. The cleaning fluid is enriched with particles held by the glass ribbon. It is therefore useful when the cleaning fluid located on the glass ribbon is regularly renewed as a function of the degree of contamination. It is especially advantageous when the cleaning fluid is fed continuously to the surface and is also naturally continuously removed from the glass ribbon after flowing over the glass ribbon, in that it can be suctioned away or it can flow into the float bath. Here, the cleaning fluid can be fed in the middle of the glass ribbon and removed at a side edge or also two side edges, but it is also possible to feed the cleaning fluid at one side edge, to allow it to run transverse over the glass ribbon, and to remove it again at the other side. The cleaning fluid is preferably fed with a suitable pump. The impurities are removed from the surface of the glass ribbon before the glass ribbon is lifted from the surface of the float bath, i.e., at a point, at which the glass ribbon has already largely solidified, i.e., become rigid enough that the cleaning fluid located on it can no longer cause any deformation.

If the cleaning fluid is fed to the glass ribbon at one position, at which it is already rigid, then one can press the side of the ribbon, at which the cleaning fluid is removed, somewhat downward in the direction of the float bath, e.g., with the help of a roller. Therefore, a trap is generated, which creates a controlled flow and simultaneously simplifies the removal of the cleaning fluid. Behind the roller, the glass ribbon then assumes its original shape again. When feeding the cleaning fluid in the middle of the ribbon, preferably both edges are pressed downward.

So that the cleaning fluid cannot extend too far along the glass ribbon, it is advantageous when the spreading of the cleaning fluid is controlled, i.e., in general limited, in and/or against the running direction of the glass ribbon. The spreading of the cleaning fluid on the glass ribbon is controlled in a contactless manner, especially through a gas flow blowing on the cleaning fluid or through the use of electric or electromagnetic fields or currents.

If the spreading is controlled by a gas flow, then a bar equipped with gas passages directed towards the glass surface is suitable. The passages can be constructed as bores or slots or can have the form of an open porous material. Guiding gas through the gas passages produces a levitating effect; the bar hovers over the glass and cannot touch the surface. This has the advantage that the spacing of the bar to the glass ribbon can be kept small, without the risk of contact between the glass and bar. The spacing of the bar from the glass ribbon should preferably equal 1 to 10 mm, in particular 3 to 7 mm.

A bar can also be used, which is arranged at a fixed spacing above the glass ribbon. Such a bar is provided with gas outlet openings pointing in the direction towards the cleaning fluid and the gas flow emerging through the openings in the direction towards the glass surface is dimensioned so that it can blow the cleaning fluid away from the bar. The flow velocity for the gas should be greater than 1 m.s⁻¹, preferably greater than 5 m.s⁻¹, in particular greater than 10 m.s⁻¹, in order to press the cleaning fluid away from the bar. It should not be so great, however, that the cleaning fluid is blown away in the form of drops. This method, however, requires relatively large amounts of preheated gas. The gas can be the inert gas, which is present in the float-glass installation and which must be led into the bar merely by means of a corresponding fan. In this case, additional heating is required only in a small degree or not at all.

Such a bar can also be charged with air or oxygen instead of with inert gas. The oxygen reacts with the float-bath atmosphere and generates a preheated gas curtain. However, through careless process control, the generated flame curtain can damage the glass surface. For controlling the spread of cleaning fluid through gas flows, however, it is expensive that gas is consumed continuously and that the gas must be heated, so that the glass ribbon is not damaged.

For a bar with a levitating effect, if the gas emerging at the side edges of the bar does not reliably prevent the cleaning fluid from contacting the bar, then additional, separate gas outlet openings pointing in the direction towards the cleaning fluid can also be formed in the bar.

The fluid limiter is generally used transverse to the advancing direction of the glass ribbon. Transverse should be understood to be not only a horizontal angle of 90° to the advancing direction, but also so that the fluid limiter can be arranged at a different angle relative to the advancing direction. In general, the angle should not be greater than 45 degrees, because otherwise the cleaning device takes up a disproportionately large space in the float chamber and the fluid limiter is very long. A small angle of approximately up to 15 degrees, however, can be advantageous, because it can promote the flow of the cleaning fluid on the glass ribbon in the direction of the edge. If an angle is used, it is useful to adapt the angle to the velocity of the glass ribbon, which can be realized through a few simple tests.

A second fluid limiter can be arranged behind the first fluid limiter viewed in the advancing direction of the glass ribbon, if there is the risk that the cleaning fluid will extend undesirably far in the ribbon advancing direction. A second fluid limiter is frequently unnecessary. In particular, it is not needed when the cleaning device is located in a spatial area of the lifting position, because the lifting angle, i.e., the resulting rising slope of the glass ribbon, limits the spread of the cleaning fluid.

The bar-shaped fluid limiter can comprise a wide variety of materials, wherein it is important that they are inert relative to the float-bath atmosphere and that they do not deform or melt at the high temperatures of ca. 600 to 1200° C. If necessary, the bar must be cooled. Suitable materials for the bar are, according to the temperature, iron or steel, tungsten, SiC, typical ceramic materials, and other temperature-resistant alloys, which can also be porous.

Very advantageously, a bar can also be used, in which suitable electric or magnetic fields are generated, which are set so that a force is generated that presses the cleaning fluid away from the bar. Through a suitable arrangement of the magnetic fields, a lateral velocity can also be impressed onto the cleaning fluid, so that the cleaning fluid also obtains a flow in the direction of the glass edge. Such a bar is very reliable as a fluid barrier and is absolutely free from contact from the glass ribbon running under it. Various forms of magnetic fields can be used, e.g., static magnetic fields, whose magnitude and direction do not change and which operate according to the principle of an eddy-current brake, variable magnetic fields, such as those used, e.g., in a linear motor, or also high-frequency alternating fields with frequencies above 250 Hz.

The fluid limiter does not have to comprise a straight bar, tube, bar, or the like, but instead can also have a curved or sweptback construction. The curved and sweptback shape should always be arranged on the ribbon so that no “dead” spaces can be formed, in which the cleaning fluid can build up without being replaced by fresh cleaning fluid.

As already discussed farther above, the cleaning fluid should be regularly renewed or preferably fed to the glass ribbon continuously. The fed cleaning fluid can be removed according to generally typical methods. Thus, the cleaning fluid fed by means of a pump on one side of the glass ribbon can also be suctioned away with a pump on the other side. It is also possible to flush the cleaning fluid away from the glass ribbon electromagnetically with a device operating according to the principle of a linear motor. If the cleaning fluid (largely) has the composition of the float bath, the fluid in the float bath can be flushed especially easily. If the mechanical condition of the glass ribbon permits, one side of the glass ribbon can be pressed deep into the float bath so that the top edge of the glass ribbon (including border) lies below the fluid level of the float bath. In this case, no suction device or the like is necessary, because the fed cleaning fluid can flow away from the surface of the glass ribbon and can flow into the bath without additional means. As a device for pressing the glass ribbon downward, a roller running in the edge area, especially at the border of the glass ribbon, can be used, but it is also possible to use a sliding block, because otherwise the border would become distorted. A gas-charged body, e.g., could also be used, which presses the glass ribbon downward due to the levitating effect. Obviously, it is also possible to press the edge of the glass downward on both sides.

The amount of cleaning. fluid fed to the glass ribbon depends on the number of particles located on the glass ribbon (i.e., on the desired cleaning effect) and can vary within a wide range, wherein the width of the glass ribbon to be cleaned is also to be taken into account. The expansion of the cleaning fluid on the glass ribbon in the longitudinal direction preferably equals 1 to 100 cm, especially 1 to 10 cm. The layer thickness of the cleaning fluid on the glass ribbon should equal, for example, 1 to 30 mm, preferably 3 to 6 mm. It is, however, dependent on the surface tension and weight of the cleaning fluid at the corresponding temperature. Care should be taken that the glass ribbon does not deform too greatly due to the weight of the cleaning fluid or that the deformation does not take place too close to the still hot, soft parts of the glass ribbon, because this can cause undesired tensile forces, which can deform the still-soft portion of the glass ribbon lying farther forwards.

The cleaning fluid can be guided very favorably between two fluid limiters. This is offered especially when the layer thickness of the cleaning fluid is to be kept high over the glass ribbon. Because the fluid would expand far onto the glass ribbon with a large layer thickness without a limiting device, through multi-sided limiting the consumption of cleaning fluid and thus the energy consumption for the pumps can be reduced. In principle, one can manage with one limiter but, if necessary, several limiters can also be arranged one behind the other, in order to reliably hold back fluid possibly not caught by one limiter. For two limiters arranged one behind the other, the spacing between both can be arbitrary, in principle, but obviously the spatial relationships in the float chamber have to be taken into account. Therefore, the spacing of the limiter should lie preferably within the specified longitudinal expansion of the cleaning fluid. The two fluid limiters can operate according to the same working principle. To rule out effects of the fluid limiters on each other, however, fluid limiters operating according to different principles can also be used, e.g., a limiter, in which a magnetic field is generated and a limiter, from which a gas flow emerges.

The subject matter of the invention is furthermore an alkali-free float glass with a transformation temperature Tg of at least 600° C. at a viscosity η of 10¹³ dPas with an exceptionally high surface quality, wherein float glass is understood to be the float glass as it comes out of the float installation, i.e., without chemical or mechanical finishing work, such as etching, grinding, polishing, and the like.

The float glass has a maximum of three surface defects (top specks) with a size of more than 50 μm per m². An alkali-free float glass with a transformation temperature Tg of at least 600° C. at a viscosity η of 10¹³ dPas and a thickness of less than 1.5 mm is preferred. It is especially suitable for the production of TFT (thin film transistor) monitors. Because thermal processes are applied during the course of the monitor production, it is advantageous to use glasses with a higher transformation temperature for the purpose of higher glass stability. Therefore, a glass with a transformation temperature Tg of 650 to 780° C., especially 700 to 730° C. is preferred. Such glasses are preferably alkali-free borosilicate glasses or aluminosilicate glasses for TFT applications. Furthermore, it is advantageous for the glass to be as thin as possible for the purpose of saving weight. Therefore, glasses with a thickness of 0.2 to 0.9 mm are preferred. The number of surface defects (top specks) and their size is important for the quality of the glass, especially for a TFT monitor application. Therefore, it is preferred when the surface defects are not greater than 35 μm, in particular, not greater than 20 μm. Because the top specks are typically round, the measure of 50 or 35 or 20 μm relates to a round-circular defect with such a diameter. For oval or similarly shaped surface defects, this measure relates to the greatest extent of the defect.

### BRIEF DESCRIPTION OF THE DRAWINGS

The invention is explained in more detail in the drawing. Shown are

FIG. 1 a schematized top view of the glass ribbon with cleaning device with side feeding of the cleaning fluid,

FIG. 2 a cross sectional view through FIG. 1 viewed from the border,

FIG. 3 a schematized top view of the glass ribbon, in which the cleaning fluid is fed at the middle,

FIG. 4 a cross sectional view through FIG. 3, viewed from the border.

### DETAILED DESCRIPTION OF THE PREFERRED EMBODIMENT

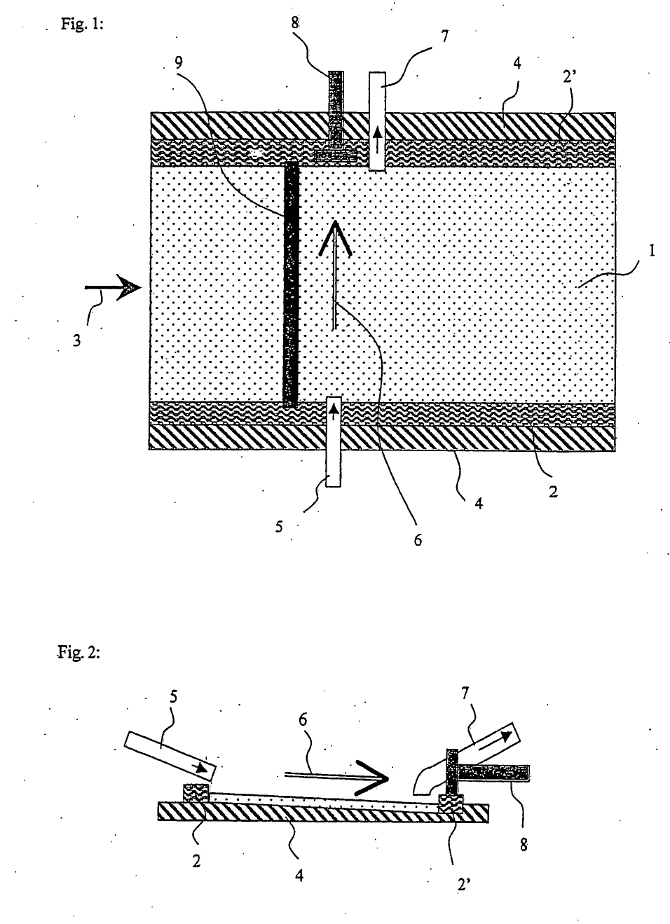

In FIGS. 1 and 2, a section from a float installation is shown schematically in top view and cross section, respectively. The glass ribbon 1, which carries borders 2 and 2′ on both edges from the preceding drawing process, moves in the direction of the arrow 3 over the float bath 4 composed of tin or a tin alloy. Cleaning fluid, in this case, molten tin, is fed through the tube 5 onto the glass ribbon 1 and flows in the direction of the arrow 6 to the opposite side of the glass ribbon. Here, the cleaning fluid is suctioned through the suction tube 7 and removed from the glass. The flow of cleaning fluid in the direction towards the suction tube 7 is supported, in that a pressure is exerted onto the border 2′ with the help of the pressure roller 8, so that the glass ribbon 1 receives a downward slope in the direction towards the suction tube 7. So that the cleaning fluid does not spread too far onto the glass ribbon 1, a fluid barrier 9 is provided. The fluid barrier 9 is composed of a bar, which is arranged above the glass ribbon and which is made, e.g., from tungsten that is held over the borders 2 and 2′ at a spacing of about 10 mm. It is provided with bores, which point in the direction towards the cleaning fluid and through which a gas flow of a total of 150 m³/h is directed with a velocity of about 20 m/s. It reliably holds back the metallic cleaning fluid. The pressure roller 8 can be composed of metal, but preferably is graphite. It is usually not driven and is used merely for exerting a pressure onto the side edge of the glass ribbon. Because the cleaning device is installed at a position in the float chamber, at which the glass ribbon can be deformed barely plastically, the glass is also not deformed permanently by the pressure roller 8.

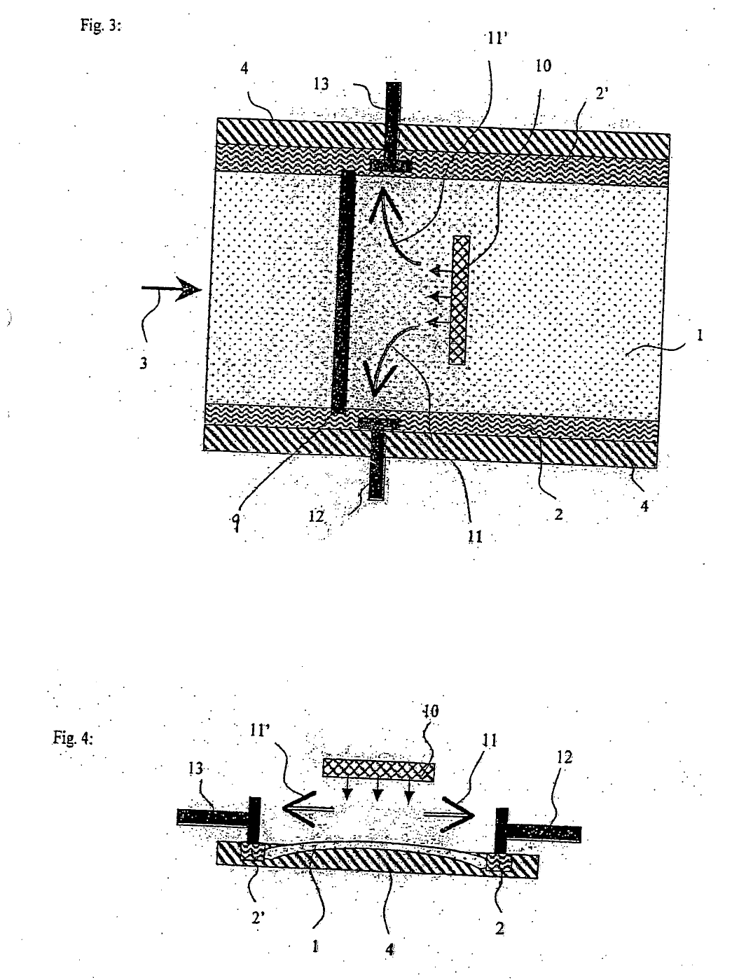

FIGS. 3 and 4 illustrate a different embodiment of the cleaning device. Here, the cleaning fluid is fed onto the glass ribbon at the middle through a feeding device 10, which has many small nozzles similar to a drip installation or also a wide-slot nozzle, and flows, as shown by the arrows, towards the two edges of the glass ribbon 1. This flow is supported in that a slightly convex surface of the glass ribbon is generated, which creates a downward slope for the cleaning fluid in the direction of the side edges, with the help of pressure rollers 12 and 13. In the illustrated representation, the side edges of the glass ribbon 1, the borders 2 and 2′, are pressed so deep into the float bath 4 that their top edge lies at the same height or below the bath level of the float bath 4. Therefore, the cleaning fluid, which is fed by the feeding device 10 and which has the same composition as the float bath 4, can run easily in the float bath without additional auxiliary means. The curvature of the glass ribbon shown in FIG. 4 is not shown true to scale. In practice, the border is also only slightly thicker than the glass ribbon and consequently the side edges (borders) must be pressed downward accordingly, so that they end below the bath level of the float bath 4. A fluid limiter 9 also provides that the cleaning fluid cannot spread against the advancing direction of the ribbon into the soft area of the glass ribbon.

With the invention, it has become possible for the first time to generate a glass, which, already in the float chamber, has such a quality that it can also be used without greater cleaning steps even in demanding fields of use.

1. Method for producing flat glass with a transformation temperature of at least 600° C. according to a float method, comprising: moving molten glass in a form of an endless ribbon within a float chamber forward on a bath of molten metal, cooling and solidifying the glass ribbon and lifting the solidified glass ribbon from the bath, removing impurities on a surface of the glass ribbon are removed by treating the surface of the glass ribbon with a cleaning fluid composed of a fluid metal within the float chamber, and controlling the spreading of the cleaning fluid on the glass ribbon in a contactless manner, through a gas flow blowing on the metal or through use of electric or electromagnetic fields or currents.

2. Method according to claim 1, wherein the cleaning fluid is regularly renewed.

3. Method according to claim 1, wherein the cleaning fluid is continuously fed to the surface of the glass ribbon.

4. Method according to claim 1, wherein the spread of the cleaning fluid in and/or against an advancing direction of the glass ribbon is limited.

5. Method according to claim 1, wherein the spread of the cleaning fluid is limited in a horizontal angle of 0 to 45 degrees relative to an advancing direction of the glass ribbon.

6. Method according to claim 4, wherein the spread is limited by a magnetic field, by which the cleaning fluid is pressed away from a bar.

7. Method according to claim 1, wherein a flow is also impressed onto the cleaning fluid.

8. Method according to claim 1, wherein the cleaning fluid comprises tin, copper, silver, gold, lead, bismuth, gallium, indium, germanium, and alloys of these metals or the float-bath fluid.

9. Device for producing float glass with a transformation temperature of at least 600° C. in ribbon form on a float bath of molten metal located in a float chamber, comprising: means for feeding fluid glass on one side of the float chamber, means for cooling the glass, and means for removing the solidified glass ribbon on an other side of the float chamber, a feeding device (5, 10) for providing a cleaning fluid comprised of fluid metal onto the largely solidified glass ribbon (1) located on the float bath, a discharge device (7) for removing [[the]] used cleaning fluid from the glass ribbon (1) located on the float bath, and pneumatic or electrical or electromechanical means for contactless control of a spread of the cleaning device on the glass ribbon.

10. Device according to claim 9, further comprising a fluid limiter (9) for preventing an excessively large expansion of the cleaning fluid, extending over an entire width of the glass ribbon that is arranged spaced apart from the glass ribbon, through which magnetic fields acting on the cleaning fluid can be generated.

11. Device according to claim 9, further comprising a fluid limiter (9) for preventing an excessively large expansion of the cleaning fluid extending over an entire width of the glass ribbon that is arranged spaced apart from the glass ribbon, through which gas flows can be directed onto the cleaning fluid.

12. Device according to claim 11, wherein the fluid limiter (9) is comprised of a bar made from open porous material or is provided with bores, so that a gas cushion can be generated between the glass ribbon and the fluid limiter.

13. Device according to claim 10, wherein the means for contactless control of the spread of the cleaning fluid are arranged on the glass ribbon in an area of the feeding and discharge device for the cleaning fluid.

14. Device according to claim 10, wherein a spacing between the fluid limiter (9) and the glass ribbon (1) equals 1 to 10 mm.

15. Alkali-free flat glass produced according to a float method with a transformation temperature Tg of at least 600° C. at a viscosity η of 10¹³ dPas with a maximum of three surface defects per m² with a size of more than 50 μm at an outlet from the float chamber.

16. Flat glass according to claim 15, wherein the flat glass has a maximum of three surface defects per m² with a size of more than 35 μm.

17. Flat glass according to claim 15, wherein the flat glass has a maximum of three surface defects per m² with a size of more than 20 μm.

18. Flat glass according to claim 15, wherein the flat glass has a maximum of 2 surface defects per m².

19. Flat glass according to claim 15, wherein the flat glass has a transformation temperature Tg of 650 to 780° C.

20. Flat glass according to claim 15, wherein the flat glass has a thickness of less than 1.5 mm.
